(19) United States
(12) Patent Application Publication
(10) Pub. No.: US 2026/0149517 A1
(43) Pub. Date: May 28, 2026

(54) METHODS, ARCHITECTURES, APPARATUSES AND SYSTEMS FOR REAL-TIME CELLULAR CHANNEL METRICS PREDICTION FOR EFFICIENT CROSS-LAYER RESOURCE OPTIMIZATION

(71) Applicant: InterDigital Patent Holdings, Inc., Wilmington, DE (US)

(72) Inventors: Subhramoy Mohanti, Santa Clara, CA (US); Muhammad Umar Bin Farooq, Tulsa, OK (US); Akshay Malhotra, San Jose, CA (US)

(21) Appl. No.: 19/120,946

(22) PCT Filed: Oct. 12, 2023
(86) PCT No.: PCT/US2023/035001

§ 371 Date: Apr. 14, 2025

Related U.S. Application Data
(60) Provisional application No. 63/416,156, filed on Oct. 14, 2022.

(51) Int. Cl. H04B 17/391; H04B 17/26; H04B 17/373

(52) U.S. Cl. CPC H04B 17/3913; H04B 17/26; H04B 17/373

(57) ABSTRACT

Procedures, methods, architectures, apparatuses, systems, devices, and computer program products for accurate cellular channel metric prediction using machine. In an embodiment, an apparatus may be configured to implement a prediction process repeated until the WTRU obtains a stop indicator, the prediction process comprising: obtaining past radio measurement data and past local sensors data of a sliding time window; training a configured ML model using the past radio measurement data and past local sensors data; predicting a channel quality metric using the ML model and current local sensors data; sending, to a network node, the predicted channel quality metric; and moving forward the sliding window starting time at a determined time instance; repeating the prediction process until the WTRU obtains a stop indicator.

### CROSS-REFERENCE TO RELATED APPLICATIONS

This application claims the benefit of U.S. Provisional Ser. No. 63/416,156 filed Oct. 14, 2022; which is incorporated herein by reference.

### FIELD

The present disclosure is generally directed to the fields of communications, software and encoding, including, for example, to methods, apparatus and systems for accurate cellular channel metric prediction using machine learning and other machine learning (ML) applications.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a signal to interference ratio (SINR) prediction at a WTRU based on historical channel data.

FIG. 3 depicts a sliding window mechanism for using historical data in order to predict channel metrics for future transmission time intervals (TTIs);

FIG. 4 illustrates cellular data exchange and channel metric calculation process combined with a ML-based channel metric prediction module;

FIG. 5 illustrates an example procedure for ML-based channel metric prediction coexisting with legacy channel metric estimation at the WTRU side;

FIG. 6 illustrates an example data flow between a base station (BS), WTRU and edge network for ML-based channel metric prediction coexisting with legacy channel metric estimation at the WTRU side;

FIG. 7 illustrates an example procedure for ML-based channel metric prediction coexisting with legacy channel metric estimation at the BS side;

FIG. 8 illustrates an example of a framework for proactive resource allocation;

FIG. 9 illustrates a procedure for predicting SINR at the WTRU based on historical time series data;

FIG. 10 illustrates an example of a proactive scheduling for a user with varying throughput requirements;

FIG. 11 illustrates an example of a proactive scheduling for another user with varying throughput requirements; and

FIG. 12 illustrates an example of a method for procedure for predicting SINR at a WTRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

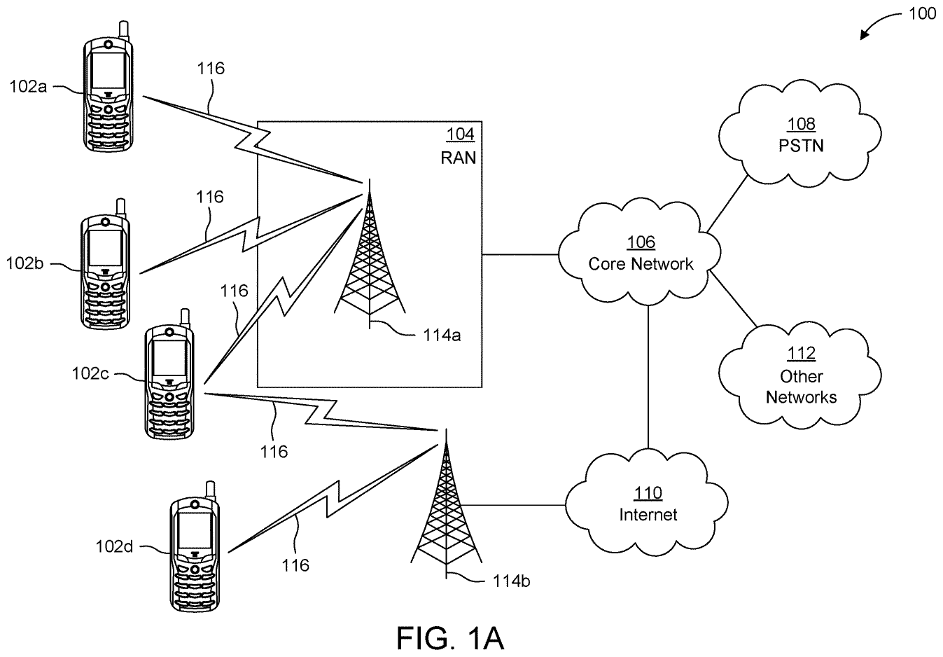

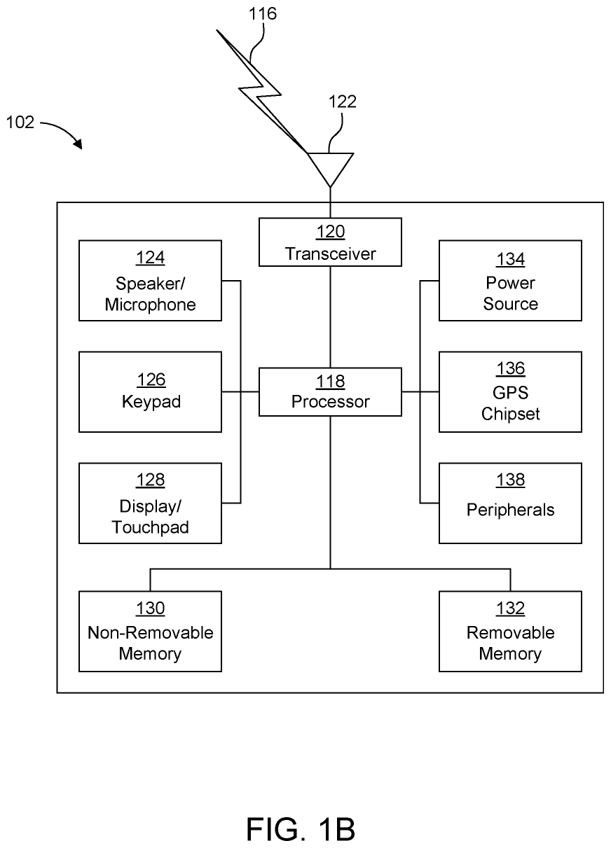

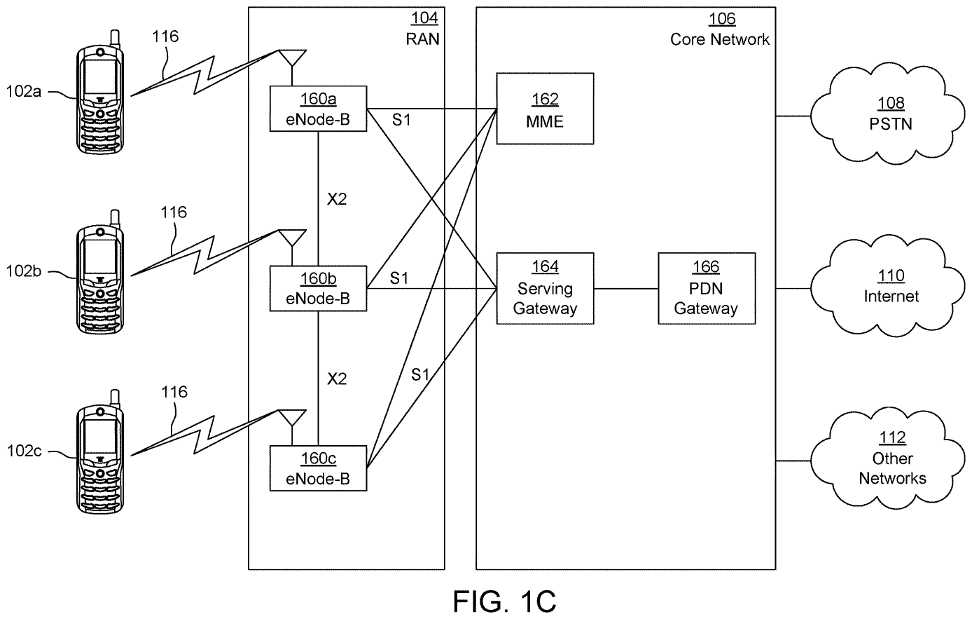

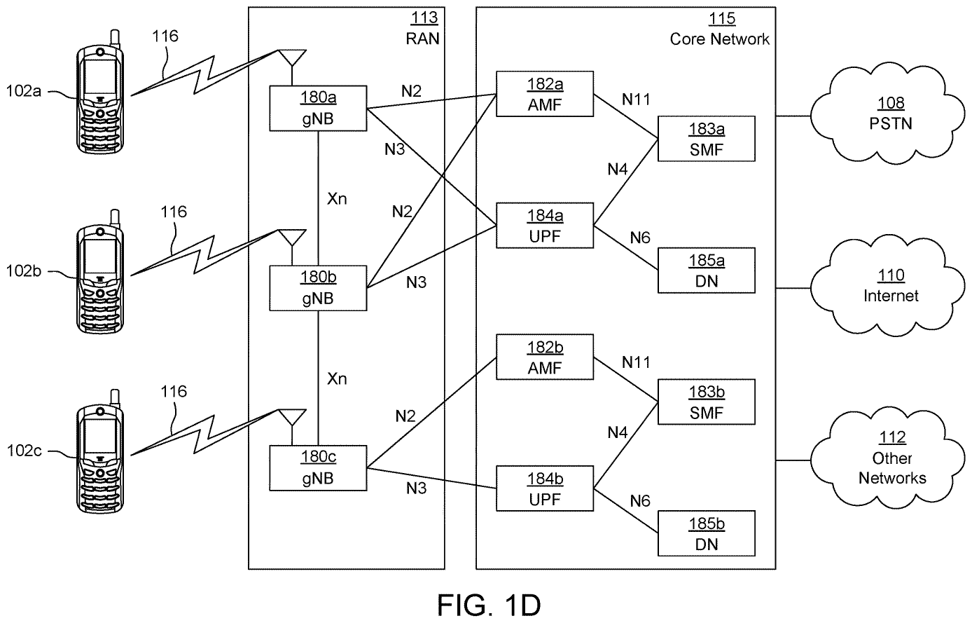

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA 2000 EV-DO, Interim Standard 2000 (IS-2000), Interim Standard 95(IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA 2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following embodiments may be described in the context of accurate cellular channel metric prediction using novel machine learning (ML) based tools, for example, for more efficient cellular network resource allocation to users. The channel quality metrics may be any of: Signal to interference ratio (SINR), received signal received power (RSRP), etc. Considering the emerging next-generation (nextG) cellular applications like augmented reality (AR)/virtual reality (VR)/extended reality (XR) having stringent quality of service (QOS) requirements, accurate prediction of channel metrics from the WTRU (e.g., UE) side may help the base station (e.g., BS/eNB/gNB) to take proactive measures to improve the key performance indicators (KPIs). This may improve the current state-of-the-art (SoA) where WTRU (e.g., UE) resource allocation may be done on a (e.g., purely) reactive approach based on instantaneous channel metrics.

Channel quality measurements may be used (e.g., essential) to determine the health of any cellular system given the current configuration. These measurements may help the WTRU (e.g., UE) and the network to make decisions so that resources are managed better and/or to achieve the required QoS.

Emerging applications like AR/VR/XR/tactile/haptic signals, have high throughput and/or strict latency and reliability constraints, which may be difficult to guarantee over wireless communication links, which are being shared with other legacy applications. Satisfying the heterogeneous QoS requirements of these diverse set of applications in dynamic, high user density environments may remain an open challenge. This may be because the current state-of-the-art in cellular network resource allocation are either static or specifically optimized for fixed use-cases and are designed to be reactive to varying channel conditions.

The following embodiments propose machine learning to predict in real-time the channel quality metrics like SINR, RSRP, etc. from historical RF (radio frequency) data and/or data from non-RF sensors present in the WTRU (e.g., UE), such as GPS, odometer, and altimeter. A multi-modal deep learning architecture is proposed that may fuse the inputs from these data sources and locally predict the channel quality metrics at the WTRU (e.g., UE), for example, enabling optimal and efficient resource allocation, in the form of physical resource blocks (PRBs) and modulation and coding scheme (MCS), for future transmit time intervals (TTIs). The impact of intermittent data (unreliable recording of SINR, RSRP, etc.) may be captured during inference, which may be possible due to interference, channel blockage due to obstacles, or hardware malfunction. The proposed architecture may be validated on live datasets collected, for example, from open-source over-the-air (OTA) 5G platforms like srsRAN running on Ettus B 210 Software Defined Radios (SDRs) and in Colosseum wireless channel emulation platform to generate data in different scenarios (static, mobile, near, far). Data may be collected from multiple WTRUs (e.g., UEs) subscribing to major cellular network providers (AT&T, Verizon, and T-Mobile) and equipped, for example, with Qualipoc mobile network testing (MNT) tool, for extracting full-stack network control information.

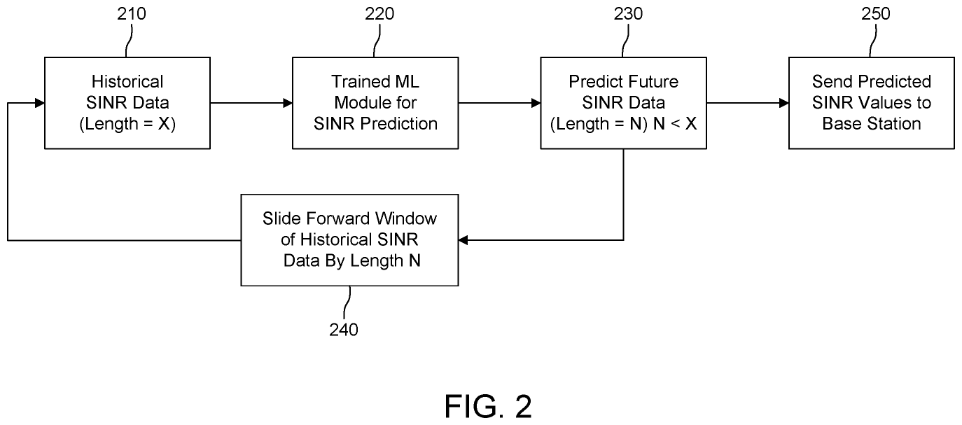

FIG. 2 illustrates an exemplary end-to-end SINR prediction system at the WTRU (e.g., UE), for example implemented using a ML module. The ML module may be trained on SINR data from different environments and/or user mobility scenarios before being deployed on UEs. The input and output of this trained ML module, e.g., the historical and predicted SINR data lengths of X and N respectively, can be set based on the desired accuracy of the SINR prediction and/or the observed dynamic nature of the wireless channel.

The SINR prediction operation is illustrated in FIG. 2 may be comprise any of the following steps:
(210) A base station (e.g., gNB) may configure the ML model for SINR prediction and/or indicate the appropriate sliding window length of historical samples to be used for prediction.
(220) Capture SINR data from previous ‘X’ TTIs at the WTRU (e.g., UE) and feed this as an input to the trained ML model residing at the WTRU (e.g., UE).
(20) The trained ML model may predict the SINR for the next ‘N’ TTIs and transmit this to the base station (250).
(240) After N future SINR datapoints are available from the ML network, the sliding window of historical SINR data may move forward by N TTIs which serves as an input to the ML module.

The ML module may predict SINR for the next N TTIs based on this updated input.

The steps 230 and 240 may be repeated, for example, until the WTRU (e.g., UE) disconnects from the cellular network.

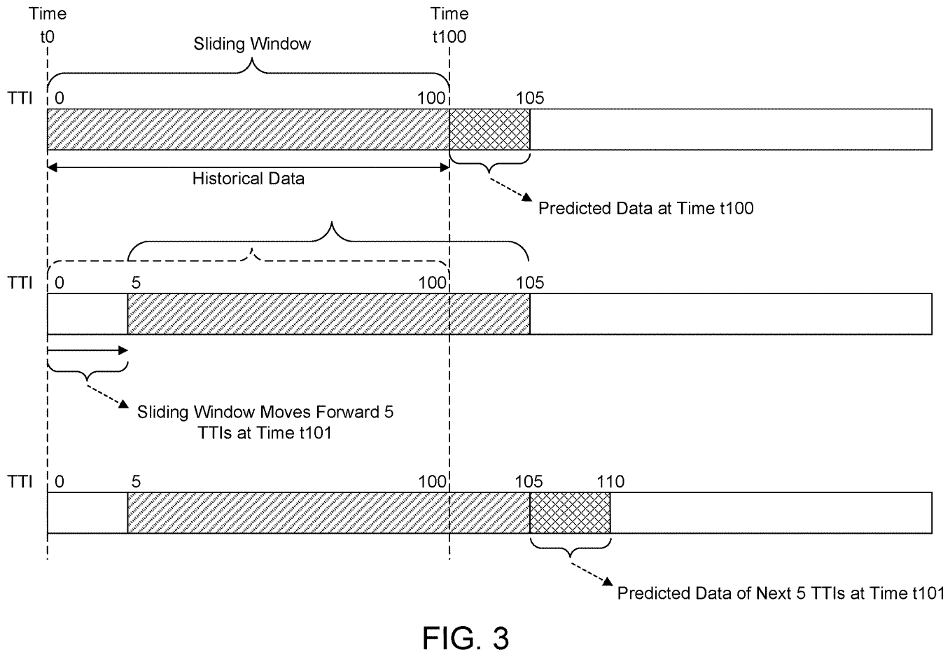

FIG. 3 illustrates an example use of historical data through a sliding window mechanism, for the channel metric prediction process. At time instant t100, the ML module may take the previous 100 TTI values of channel metrics (till time instant to) to predict the channel metrics of the future 5 TTIs (from time t101 till t105). Each TTI may correspond to a specific time instant. In the next time instant t101, the channel metric input to the ML module may move forward by 5 TTIs, and the resulting channel metrics from TTI 5 till 105 are used by the ML module to predict the channel metrics of the next future 5 TTIs #106 till #110. This process may be repeated as time progresses, for example, until the WTRU (e.g., UE) decides to stop the prediction process due to the ML module performance in terms of accuracy goes below a pre-defined threshold and/or the WTRU (e.g., UE) may disconnect from the mobile network.

The problem of cellular network resource allocation may be solved in a reactive approach by: (i) probing all the recorded channel metrics, (ii) extracting full channel state information, (iii) WTRU (e.g., UE) location tracking, (iv) sensing active applications in the WTRU (e.g., UE) for measuring QOS threshold. All these techniques focus on a centralized system with the challenge of maintaining varying rates of data transfer, in a reactive manner, across WTRUs (e.g., UEs) through a shared spectrum which is susceptible to saturation, interference and environmental degradation. These problems may be overcome by predicting the channel metrics using multi-modal data and/or undertaking proactive network resource allocation techniques to maximize the number of WTRUs (e.g., UEs) experiencing the 3GPP mandated QoS thresholds through a deep learning framework.

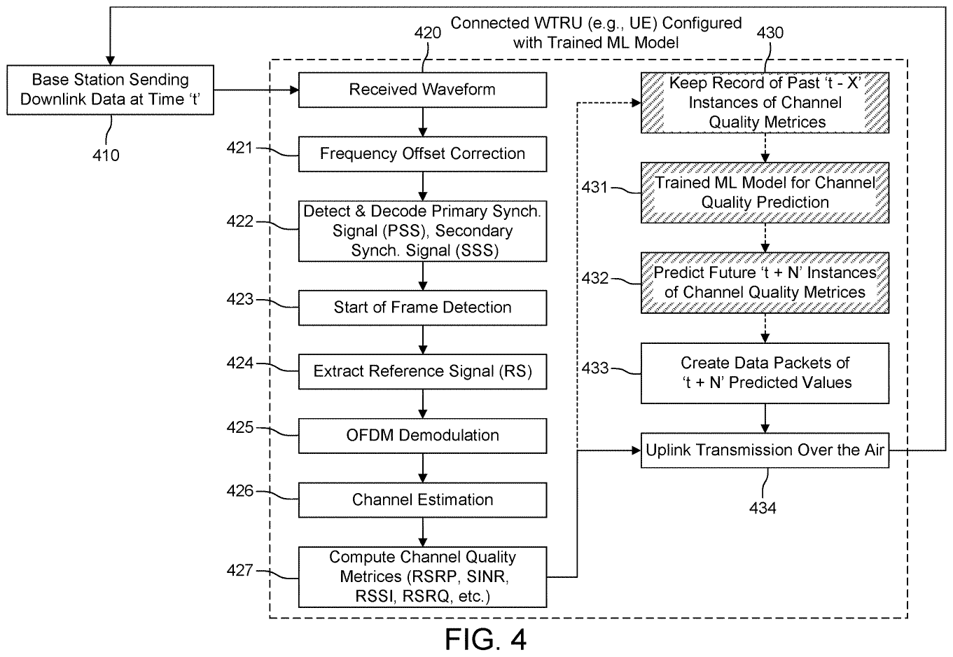

FIG. 4 illustrates the detailed data exchange and channel metric calculation process for a particular time instance ‘t’. A detailed description of this process is given below. The WTRU (e.g., UE), for example, once connected to the BS, may capture and decode bursts of downlink cellular data frames (420) that are transmitted from the BS (410) and intended for the WTRU (e.g., UE). For each captured frame, the WTRU (e.g., UE) may decode the master information block (MIB), and if decoding is successful, it may proceed to perform frequency offset correction (421). The WTRU (e.g., UE) may proceed to the blind cell search to obtain cell identity and timing offset from the Secondary Synchronization Signal (SSS) (422) and may detect the start of the frame (423). The WTRU (e.g., UE) may start the OFDM demodulation (425) of the received data followed by channel estimation, for example, with the help of the extracted reference signals (RS) (424). The WTRU (e.g., UE) may start to compute the channel quality metrics (427) like SINR, RSRP, RSRQ, RSSI, etc. from the reference signal (RS). RS may be used in the DL direction in 5G NR, for the purpose of channel sounding and may be used to measure the characteristics of a radio channel so that it can use correct modulation, code rate, beam forming etc. WTRUs (e.g., UEs) may use these reference signals to measure the quality of the DL channel and report this in the Uplink (UL) through the channel quality indicator (CQI) reports (426).

SINR represents the linear average over the power contribution (in Watts) of the resource elements carrying RS divided by the linear average of the noise and interference power contribution (in Watts) over the resource elements carrying RS within the same frequency bandwidth. The wanted signal power and/or the interference plus noise power may be measured from resource elements (REs) used by the RS. RSRP (reference signal received power) is the linear average over the power contributions of the resource elements of the antenna ports, which carry RS configured for RSRP measurements. This measurement may be performed across ‘M’ number of resource blocks (measurement bandwidth). ‘M’ is a number of RBs in RSSI measurement bandwidth. RSSI (received signal strength indicator) is defined as the linear average of the total received power observed (e.g., only) in the OFDM symbols, in which RS is present. This measurement may be also performed across N number of resource blocks (measurement bandwidth). RSSI may include the power from sources, such as co-channel serving and non-serving cells, adjacent channel interference, and thermal noise. RSRQ (reference signal received quality) is defined as, M*(RSRP/RSSI).

The WTRU (e.g., UE) may keep a database of the historical channel metrices (430), which is used for the offline training of the ML process to predict the future ‘N’ instances of channel metrices from the previous ‘X’ instances (431). After the training process is completed, the trained ML module may be transferred over the air to the WTRU (e.g., UE), which may be started to actively forecast the channel metrices (SINR, etc.) (432), for example, at every instance of downlink data reception from the BS. The WTRU (e.g., UE) may create data packet of t+N predicted values (433). These predicted values may be transmitted to the BS (434), for example, through the legacy uplink method.

The current state-of-the-art in cellular network resource allocation are either static or specifically optimized for fixed use-cases and are designed to be reactive to varying channel conditions. These solutions may not be scalable to meet the stringent QoS requirements of upcoming URLLC (ultra reliable and low latency) applications like AR/VR/XR. The described embodiments propose machine learning to predict in real-time the channel quality metrics like SINR, RSRP, etc. from historical RF data and data from non-RF sensors present in the WTRU (e.g., UE), such as GPS, odometer, and altimeter. Based on this predictive analysis and information, more efficient resource allocation and cross layer optimization can be performed to serve the maximum number of users with heterogeneous QoS requirements.

Robust ML architectures may be designed to predict the channel metrics for upcoming TTIs from historical RF data and non-RF data from devices such as GPS, odometer, and altimeter, wherein the processing steps are contained within the WTRUs (e.g., UEs). A multi-modal data reconstruction technique may be incorporated into the proposed embodiments, making channel metric prediction resilient to missing channel and sensor information.

According to embodiments, a robust machine learning based channel metric prediction mechanism may enable proactive cellular network resource optimization for data communication. This technology can predict the channel metrics and can enable proactive network resource optimization in varying channel conditions. The current state-of-the-art for network resource allocation is purely reactive and may incur a significant amount of network recovery time during degraded channel conditions.

The proactive nature of resource allocation may result in improvement in network packet delivery ratio compared to the major cellular network carriers while maintaining latency with the globally optimal solution.

The proposed machine learning framework may be resilient enough to withstand missing channel measurements and can provide accurate results even when all sensors are missing some consecutive samples.

This proposed machine learning framework may be used in different application areas beyond wireless communication like WTRU (e.g., UE) location prediction, WTRU (e.g., UE) data traffic pattern prediction, etc.

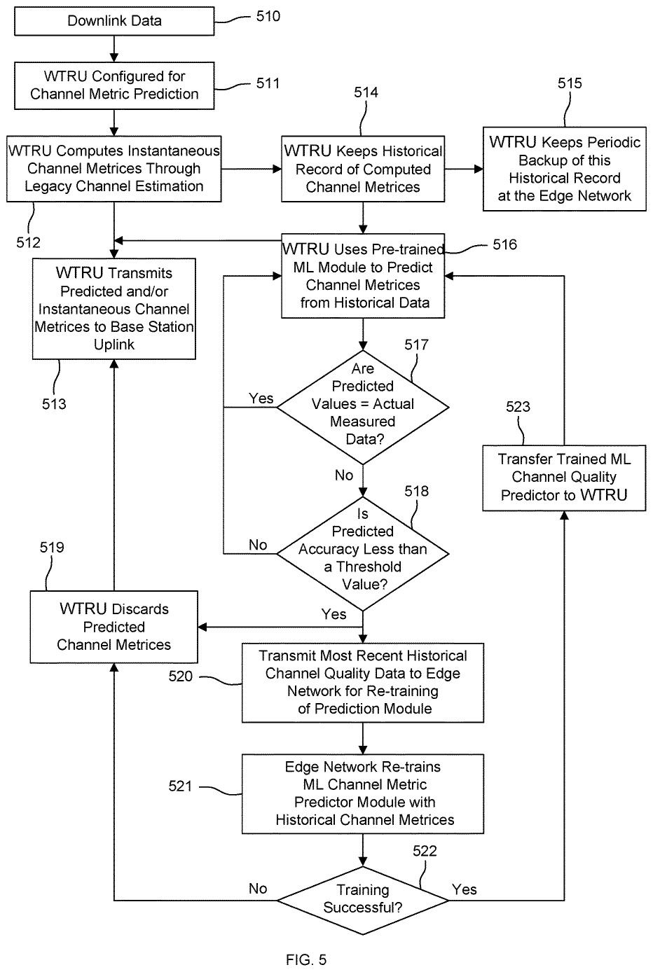

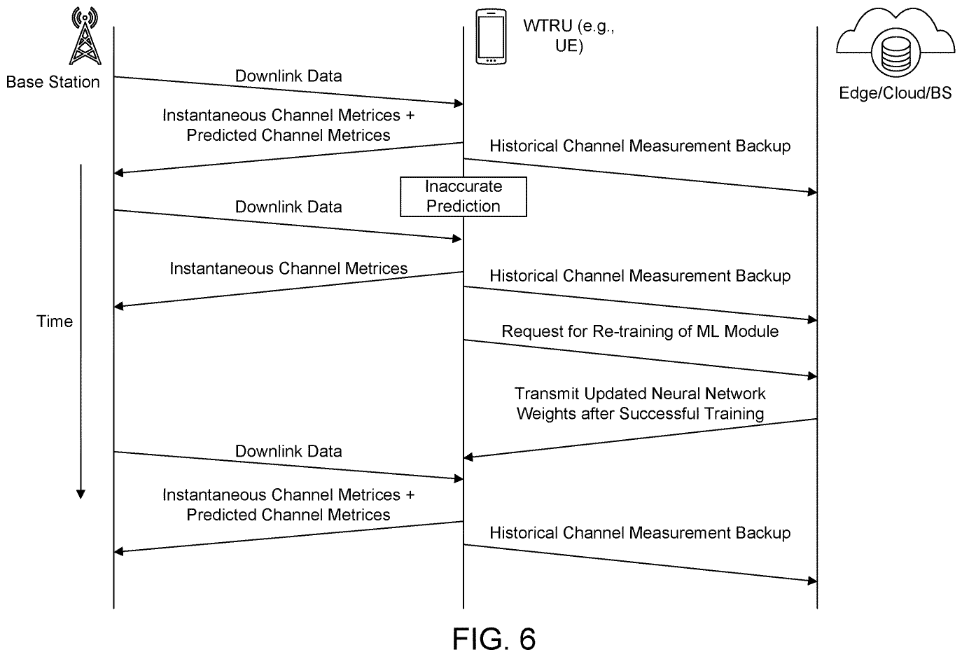

The framework of this process is depicted in FIG. 5 and this data exchange process between all the concerned entities is illustrated, on a time scale, in FIG. 6.

The WTRU (e.g., UE) channel metric prediction process may start once the WTRU (e.g., UE) has successfully connected to a BS and/or is actively receiving downlink data packets from the BS (510). This may be made possible since the ML-based channel metric prediction module is trained offline, for example, with wireless channel data in different scenarios of urban, rural, and semi-urban settings. The ML model may be available at the WTRU (e.g., UE) or may be configured by the BS (e.g., gNB) when the channel metric prediction is used (e.g., required) (511). There may be multiple ML models available at the WTRU (e.g., UE) and the BS (e.g., gNB), depending on channel derived metrics or prior information, may select the ML model to be used for prediction.

The WTRU (e.g., UE) may compute instantaneous channel metrices through legacy channel estimation (512).

With the ML channel metric prediction module active in the WTRU (e.g., UE), for example, as soon as the WTRU (e.g., UE) may come online and start to receive downlink data packets, the ML module may proceed to predict the future ‘N’ instances of channel metrices (516). The WTRU (e.g., UE) may keep periodic backup of the computed channel metric values (514, 515), for example on the Edge Network, for future re-training purpose of the ML module. The Edge Network may also keep a copy of the ML module residing in the WTRU (e.g., UE) for this purpose. The ML module in the WTRU (e.g., UE) may undergo different re-training sessions during which times it may not be active and the predicted channel metrices may not be available. These re-training occasions may occur periodically, aperiodically, or semi-persistently. Period training occasions may be configured with any of: periodicity, offset, start time, end time. For example, the re-training of the ML module can be due to bit error rate (BER) above the application/network mandated threshold, handover scenario, change or addition or removal or activation or deactivation of a serving base station, prediction accuracy of the ML module itself being below a threshold (518), etc. During these scenarios, the WTRU (e.g., UE) or the BS (e.g., gNB) may instantiate re-training of the ML module (521), for example at the Edge/Cloud network, which can be maintained by the WTRU (e.g., UE) vendor and/or the network provider. The re-training can also happen locally on the WTRU (e.g., UE) side if the WTRU (e.g., UE) has sufficient computing capability. During this re-training phase ML module residing in the WTRU (e.g., UE) can either be deactivated or the predicted values from the ‘stale’ ML module (which is not yet updated with the fully trained neural network weights from the edge/cloud) will not be included in the uplink transmission from the WTRU (e.g., UE) to the BS (519). In the absence of the predicted channel metrices, the WTRU (e.g., UE) may fall back on the legacy method of instantaneous channel metric computation and transmission from every downlink data packet (513). Once the re-training of the ML module is complete in the edge network, the neural network weights may be copied to the ML module in the WTRU (e.g., UE) (522, 523) and it may start the channel metric prediction process.

The WTRU (e.g., UE) may also decide to use non-RF data sources in the WTRU (e.g., UE) like GPS and perform fusion of multi-modal data to increase the accuracy of the predicted channel metrices by providing a comprehensive representation of the environment. The WTRU (e.g., UE) may periodically transmit the historical GPS data along with the historical channel metrices to the Edge Network. The WTRU (e.g., UE) may have the flexibility to adjust the contribution of each modality in the ML network according to their performance optimality. For example, the speed of the WTRU (e.g., UE) can be inferred from the GPS data over time, hence inferring the stability of the wireless channel in time sequence. Since, in high mobility scenarios the channel will be less stable over consecutive time instances, the ML model will learn to predict channel metrices for shorter duration in the future with greater accuracy as compared to near-static cases or walking scenarios when the channel metrices could be predicted for longer durations in the future by taking advantage of the more stable channel.

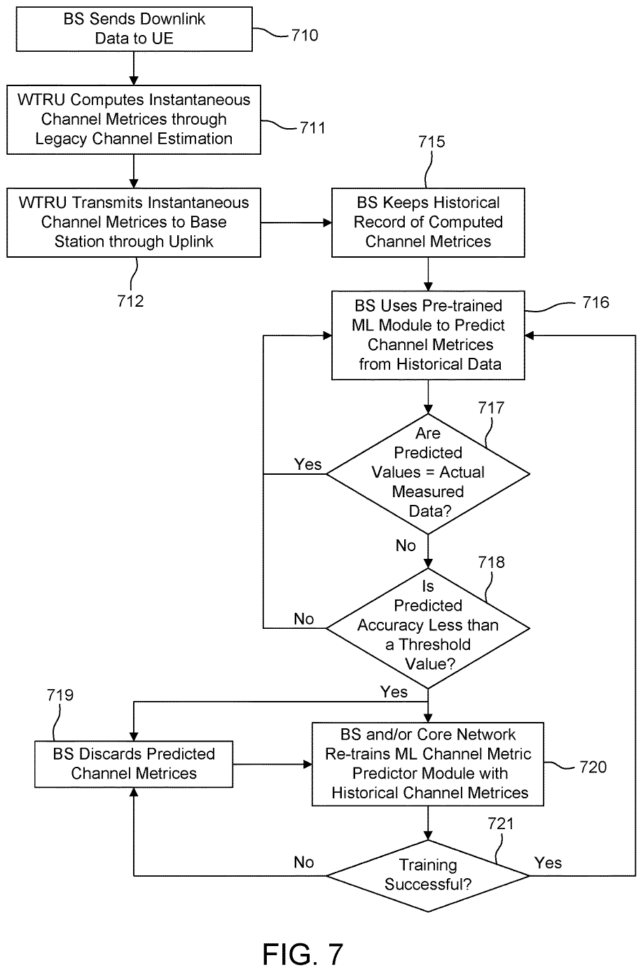

The channel metric prediction can also happen entirely in the BS, as depicted in FIG. 7.

The WTRU (e.g., UE) may receiving downlink data packets from the BS (710). The BS may keep the historical record of the instantaneous channel metrics (715), which may be shared by the WTRU (e.g., UE) in the traditional uplink process (711, 712), after the BS sends downlink data to the WTRU (e.g., UE) (710). The ML module, which may reside in the BS/core network may use this historical data in the same manner as explained before in FIG. 2, to predict the future channel metric values (716). At every TTI/time instant, the historical data may move forward by the same sliding window method as explained in FIG. 3. The BS/core network may proceed to use these forecasted channel metrics to their advantage for more efficient network resource allocation and/or preventive measures to ensure optimal QoS for the active applications in the WTRUs (e.g., UEs). The BS/core network may keep track of the prediction accuracy of these channel metrics with the reported instantaneous channel metric values from the WTRU (e.g., UE) (717). If the prediction accuracy falls below a threshold or if any of the aforementioned triggering factors are encountered (718), then the BS/core network may temporarily pause the prediction. It may start to re-train the ML module with the most recent historical channel metric data as reported by the WTRU (e.g., UE) (720). During this re-training phase ML module can either be deactivated or the predicted values from the ‘stale’ ML module (which is not yet updated with the fully trained neural network weights from the edge/cloud) may be discarded (719). Once the ML re-training is successfully complete (721), the BS/core network may restart the channel metric prediction process. This prediction process may continue till the WTRU (e.g., UE) has detached/disconnected from the network.

In the current SoA, the wireless channel conditions on the WTRU (e.g., UE) side are (e.g., only) collected in real-time by the UEs and reported back to the core network. In such cases, the core network can detect a poor channel condition only after it has occurred and has been reported by the UE. This may lead to degraded QoS at the WTRU (e.g., UE) side till the core network can re-allocate network resources for the affected UEs. For cellular networks to enable the autonomous operation of robots in smart factory environments (an example URLLC application), these short occurrences of degraded QoS can lead to disastrous consequences where the robots can experience collisions, resulting in loss of revenue. Other applications like AR/VR/XR require high throughput and low latency while the users are constantly in motion, which results in fast changing of channel quality over time. If the enabling cellular network struggles to maintain the QoS through the current SoA reactive approach, then users will experience video jitter, non-synchronized audio-video, etc., leading to a general loss of user Quality of Experience (QoE). Thereby, the accurate prediction of channel quality metrices like SINR, will circumvent this shortcoming of the current SoA.

When WTRUs (e.g., UEs) share the accurate predictions of wireless channel quality metrices like SINR, with the cellular core network, then the network service providers will have a better chance at improving the user QoS/KPIs with this forecasted information, compared to the current SoA reactive way of maintaining KPIs. This improvement will be more prominent in the above-mentioned cellular applications which have stringent QoS requirements. One of the possible ways the core network can leverage this predicted data, for example, is with proactive resource allocation for the UEs. By analyzing the forecasted wireless channel conditions for all the subscribed UEs, the core network can take pre-emptive measures to efficiently allocate network resources (frequency, bandwidth, resource blocks, scheduling, etc.) for the UEs, ahead of time. To maintain the KPIs of applications requiring stringent QoS requirements, in degraded wireless channel conditions, this method will be highly beneficial. The UEs running these applications will be able to predict wireless channel degradation and make the core network aware of this forecast. This near-future situational awareness can help the core network to effectively allocate network resources for these UEs in those future time intervals where the wireless channel is predicted to degrade, in order to remain within the application mandated QoS threshold (throughput, latency, etc.).

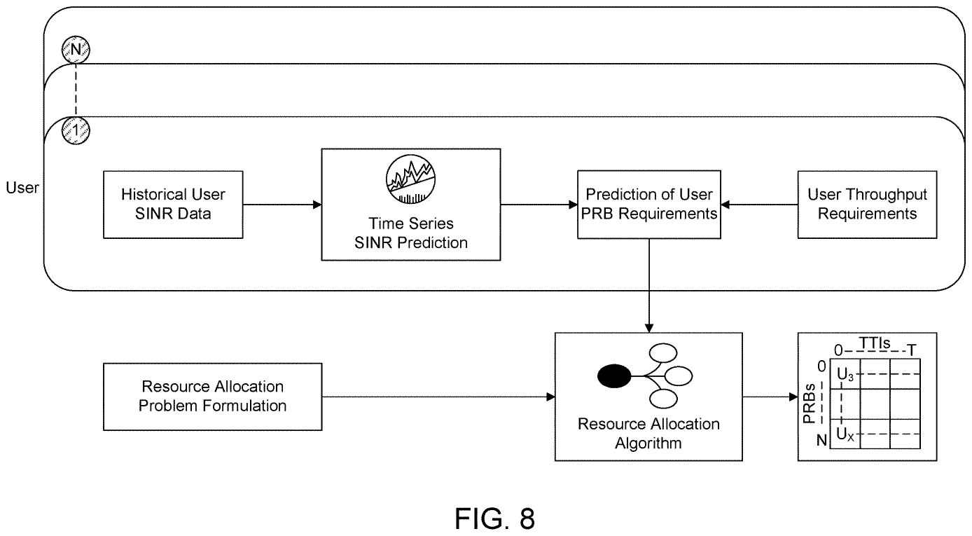

FIG. 8 illustrates a framework for proactive resource scheduling. The framework may rely on the historical SINR values of a user to train a time series model, which can predict future SINR values of the user. Once the future SINR values are known, the number of PRBs used (e.g., required) to meet the minimum throughput requirement can be calculated. Once the future required PRBs are calculated for each user, the resource allocation algorithm can proactively allocate resources to users. The resource allocation algorithm may be formulated as a knapsack problem and use iterative method to solve the knapsack problem.

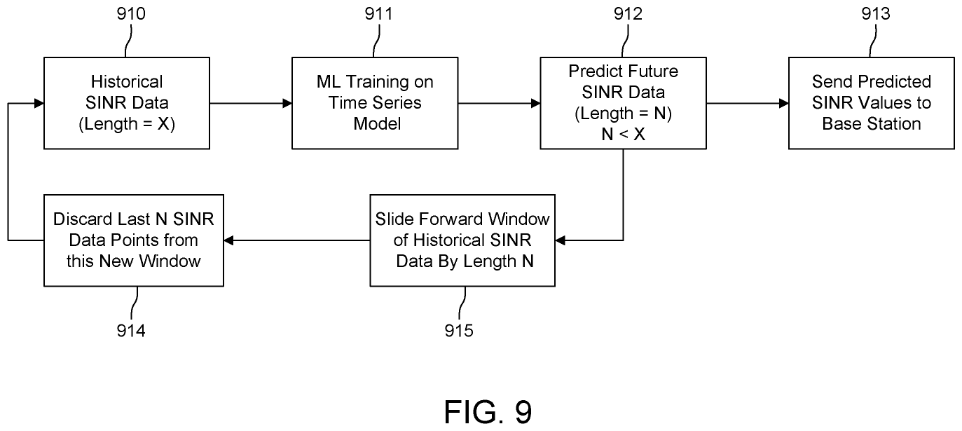

FIG. 9 illustrates an exemplary end-to-end SINR prediction system at the WTRU. The historical and predicted SINR data lengths of X and N respectively, can be set based on the desired accuracy of the SINR prediction and the observed dynamic nature of the wireless channel.

The SINR prediction operation, as shown in FIG. 9, may comprise any of the following steps:
Use X historical SINR datapoints from WTRU (e.g., UE) to train time series model (910-911).
Predict the next N SINR values using the trained model and send the predicted N SINR values to the BS (912).
After N new datapoints are available from the ML network (915), discard the first N SINR datapoints from X (914) and append the newly available N SINR data points at the end. Use these new datapoints to train a new time series model for SINR prediction.
Use the new model to predict N SINR values using the new trained model.
Repeat steps 915 and 914 until the WTRU (e.g., UE) is in connected mode.

For SINR time series prediction, an autoregression time series model may be trained with X=100 (100 SINR historical samples). The RMSE between the actual and predicted SINR is 0.6969 dB when the model is predicting future 1 SINR value (N=1). However, this RMSE increases a bit to 0.9677 dB when the model predicts future 5 SINR values (N=5).

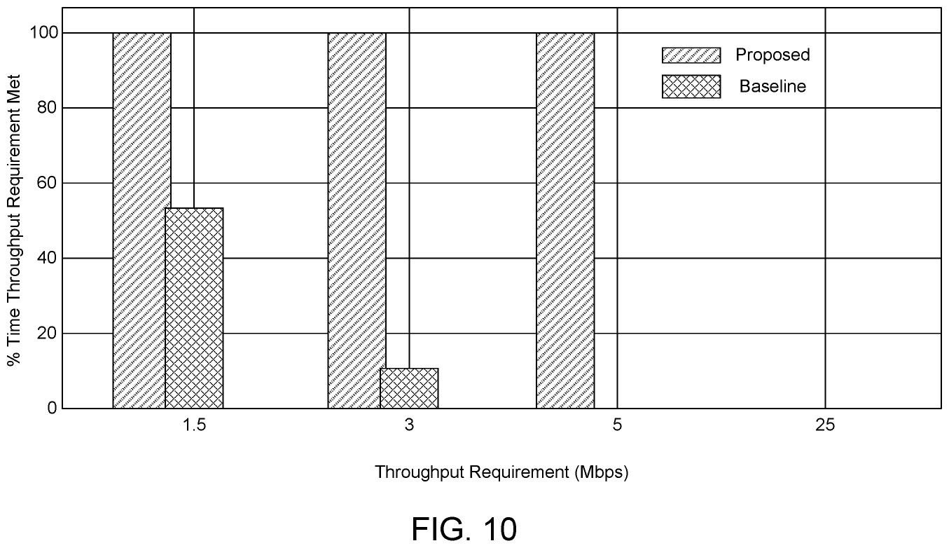

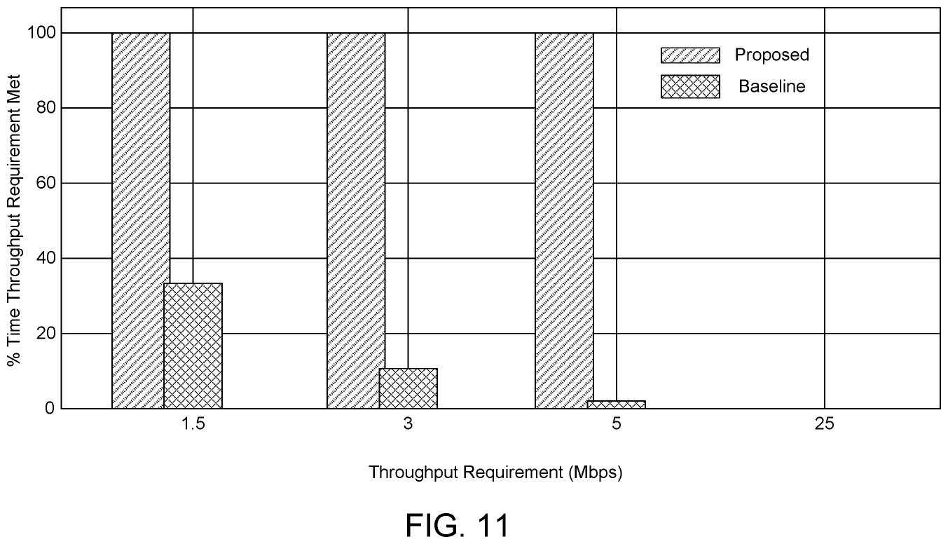

To evaluate the initial performance of the proactive resource allocation framework presented in FIG. 8, autoregression based SINR prediction may be used with X=100 and N=5 as it gives acceptable prediction accuracy. The system performance may be tested with varying throughput requirements of users. The initial results are shown with two users and a base station with 50 PRBs. The baseline scenario corresponds to the throughput observed with the srsRAN experimentation. FIG. 10 and FIG. 11 show the percentage of time throughput is met for first user and second user, respectively. It is observed that the proposed scheme can meet the requirements for both the users up to 5 Mbps. However, the users never reach 25 Mbps with 50 PRBs showing that higher bandwidths are required to meet the 25 Mbps throughput.

The proactive and intelligent mechanism can help to meet the highly dynamic requirements of future cellular networks. The data from the wireless testbeds can enable the design of these proactive intelligent mechanisms. Historical data such as SINR can be used to predict the future SINR values using time series models. This prediction of future key performance indicators such as SINR can be used for proactive network management tasks such as proactive resource allocation. Initial results indicate that the proposed proactive allocation can better meet the user requirements compared to the baseline implementation.

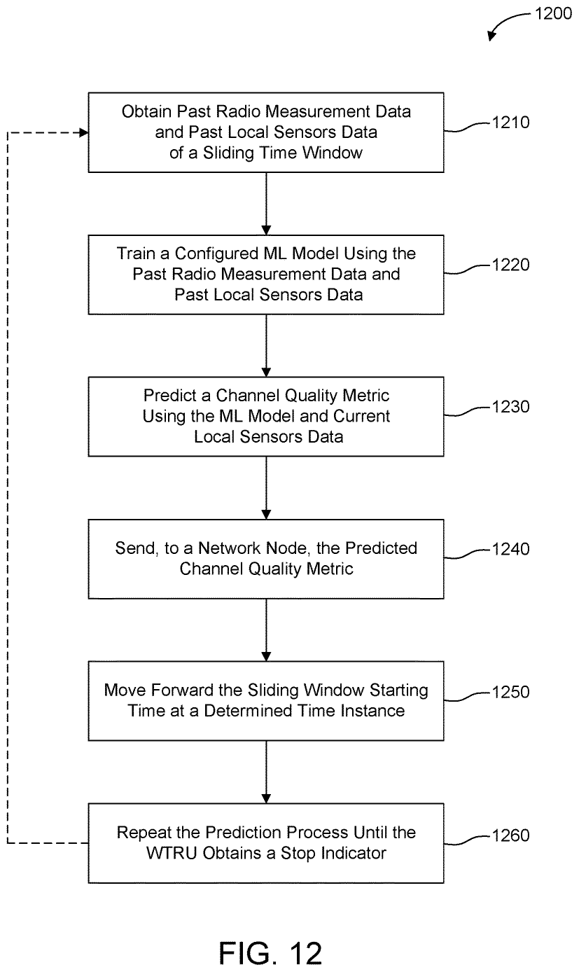

FIG. 12 illustrates an example of a method 1200 implemented in a WTRU 102 comprising a plurality of antennas and corresponding antenna ports.

According to embodiments, the WTRU 102 may be configured to implement a prediction process. The prediction process may comprise any of: obtaining past radio measurement data and past local sensors data of a sliding time window (1210); training a configured ML model using the past radio measurement data and past local sensors data (1220); predicting a channel quality metric using the ML model and current local sensors data (1230); sending, to a network node, the predicted channel quality metric (1240); and moving forward the sliding window starting time at a determined time instance (1250).

According to embodiments, the WTRU 102 may be configured to repeat the prediction process until the WTRU obtains a stop indicator (1260).

According to embodiments, the stop indicator may be obtained based on an accuracy of the trained ML model.

According to embodiments, the stop indicator may be obtained based on a disconnection of the WTRU from a network node.

According to embodiments, the WTRU 102 may be configured to start the prediction process based on a connection to a network node and/or a reception downlink data packet from the network node.

According to embodiments, the ML model may be configured by the network node.

According to embodiments, the WTRU 102 may be configured to select the ML model from a plurality of ML models.

According to embodiments, the WTRU 102 may be configured to send information indicating a re-training of the ML model at an edge network and/or the network node.

According to embodiments, the ML model may be based on a re-trained ML model at the edge network and/or the network node.

According to embodiments, the WTRU 102 may be configured to send information indicating the past radio measurement data and past local sensors data to the edge network and/or the network node.

According to embodiments, the network node may be a base station.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.” One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method, implemented by in a wireless transmit/receive unit (WTRU), the method comprising:
a prediction process comprising:
obtaining historical radio frequency (RF) data and first data from non-RF sensors of the WTRU from a first one or more historical transmission time intervals of the WTRU;
performing fusion of the historical RF data and the first data;
training a configured machine learning (ML) model using the historical RF data, the first data, and the fusion of the historical RF data and the first data;
predicting a channel quality metric using the ML model and current data from the non-RF sensors;
sending, to a network node, the predicted channel quality metric; and
moving forward the first one or more historical transmission time intervals to a second one or more historical transmission time intervals by a number of transmission time intervals;
repeating the prediction process until the WTRU obtains a stop indicator.

2. The method according to claim 1, wherein the stop indicator is obtained based on an accuracy of the trained ML model.

3. The method according to claim 1, wherein the stop indicator is obtained based on a disconnection of the WTRU from another network node.

4. The method according to claim 1, further comprising:
starting the prediction process based on one or more of a connection to another network node and/or a reception downlink data packet from the other network node.

5. The method according to claim 1, wherein the ML model is configured by the network node.

6. The method according to claim 1, further comprising:
selecting the ML model from a plurality of ML models.

7. The method according to claim 1, further comprising:
sending information indicating a re-training of the ML model at one or more of an edge network and the network node.

8. The method according to claim 7, wherein the ML model is based on a re-trained ML model at one or more of the edge network and the network node.

9. The method according to claim 7, further comprising:
sending third information indicating the historical RF data and the first data to one or more of the edge network and the network node.

10. The method according to claim 1, wherein the network node is a base station.

11. A wireless transmit/receive unit (WTRU) comprising circuitry, including a transmitter, a receiver, a processor and memory, the WTRU configured to:
implement a prediction process comprising:
obtaining historical radio frequency (RF) data and first data from non-RF sensors of the WTRU from a first one or more historical transmission time intervals of the WTRU;
performing fusion of the historical RF data and the first data;
training a configured machine learning (ML) model using the historical RF data, the first data, and the fusion of the historical RF data and the first data;
predicting a channel quality metric using the ML model and current data from the non-RF sensors;
sending, to a network node, the predicted channel quality metric; and
moving forward the first one or more historical transmission time intervals to a second one or more historical transmission time intervals by a number of transmission time intervals;
repeat the prediction process until the WTRU obtains a stop indicator.

12. The WTRU according to claim 11, wherein the stop indicator is obtained based on an accuracy of the trained ML model.

13. The WTRU according to claim 11, wherein the stop indicator is obtained based on a disconnection of the WTRU from another network node.

14. The WTRU according to claim 11, further configured to:
start the prediction process based on one or more of a connection to another network node and a reception downlink data packet from the other network node.

15. The WTRU according to claim 11, wherein the ML model is configured by the network node.

16. The WTRU according to claim 11, further configured to:
select the ML model from a plurality of ML models.

17. The WTRU according to claim 11, further configured to:
send information indicating a re-training of the ML model at one or more of an edge network and the network node.

18. The WTRU according to claim 17, wherein the ML model is based on a re-trained ML model at one or more of the edge network and the network node.

19. The WTRU according to claim 17, further configured to:
send information indicating third information indicating the historical RF data and the first data from the non-RF sensors from the historical transmission time intervals to one or more of the edge network and the network node.

20. The WTRU according to claim 11, wherein the network node is a base station.
